(19) United States
(12) Patent Application Publication
(10) Pub. No.: US 2013/0160009 A1
(43) Pub. Date: Jun. 20, 2013

(54) CONTROL COMPUTER AND METHOD FOR DEPLOYING VIRTUAL MACHINES

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); HO-I SUN, New Taipei (TW)

(73) Assignee: HON HAI PRECISION INDUSTRY CO., LTD., New Taipei (TW)

(21) Appl. No.: 13/707,661

(22) Filed: Dec. 7, 2012

(30) Foreign Application Priority Data
Dec. 15, 2011 (TW) 100146656

(51) Int. Cl. G06F 9/455

(52) U.S. Cl. CPC G06F 9/45533
USPC 718/1

(57) ABSTRACT

In a method for deploying a virtual machine in a data center, a user request for installing a virtual machine in a data center and a specified amount of computing resources required by the virtual machine are received from a client computer. An amount of available computing resources of each physical machine in the data center is determined and compared with the specified amount of computing resources required by the virtual machine. One or more physical machines that satisfy the specified amount of computing resources required by the virtual machine are obtained. According to a deployment strategy of the virtual machine, a physical machine is determined from the one or more physical machines. The virtual machine is deployed in the determined physical machine.

### BACKGROUND

1. Technical Field

Embodiments of the present disclosure relate to virtual machine technology, and particularly to a control computer and method for deploying virtual machines in a data center.

2. Description of Related Art

In cloud computing technology, a plurality of physical machines (e.g., servers) are included in a data center. Each physical machine can be installed with a plurality of virtual machines (VMs) for providing multiple services to users. Each virtual machine occupies certain computing resources (e.g., CPU, memory, and hard disk) of the physical machines. When a new virtual machine is required to be installed in the data center, an appropriate physical machine is needed to be determined to deploy the virtual machine.

### BRIEF DESCRIPTION OF THE DRAWINGS

FIG. 1 is one embodiment of an application of a control computer.

FIG. 2 is a block diagram of one embodiment of function modules of a virtual machine deployment system in FIG. 1.

FIG. 3 is a flowchart of one embodiment of a method for deploying virtual machines in a data center using the control computer of FIG. 1.

FIG. 4 is a table showing one embodiment of various types of virtual machines and computing resources required by the various types of virtual machines.

FIG. 5 is a table showing one embodiment of available computing resources of physical machines in a data center.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

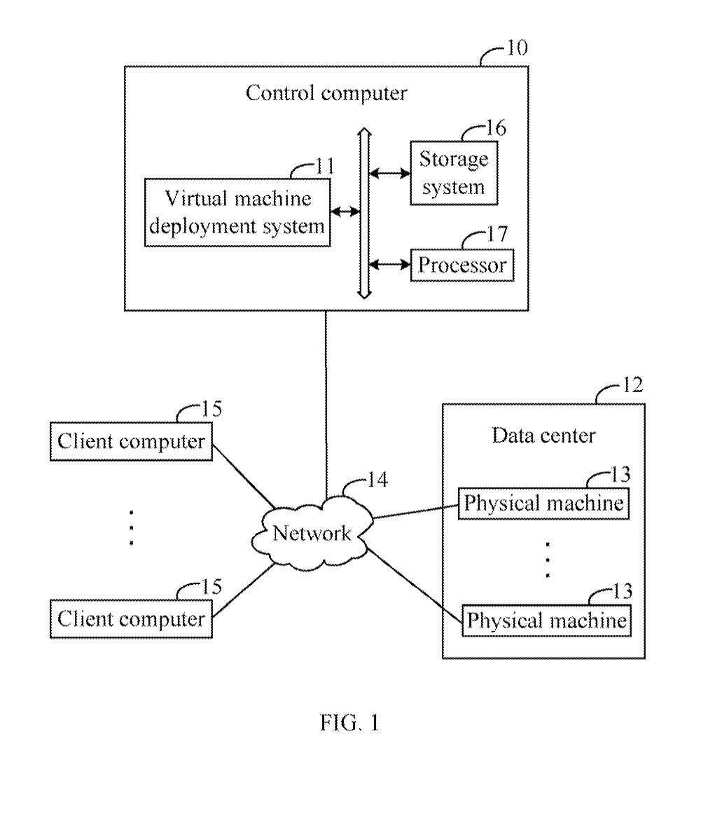

FIG. 1 is one embodiment of an application of a control computer 10. The control computer 10 is connected to a data center 12 through a network 14. The data center 12 includes a plurality of physical machines (e.g., servers) 13, each of which can be installed with one or more virtual machines. A plurality of client computers 15 are connected to the data center 12 via the network 14 to use the virtual machines. The control computer 10 includes a virtual machine deployment system 11. The virtual machine deployment system 11 receives a user request for installing a virtual machine in the data center 12 from one of the client computers 15, and deploys the virtual machine in an appropriate physical machine 13. The network 14 may be the Internet, an intranet, or any other suitable network.

In this embodiment, the control computer 10 further includes a storage system 16 and at least one processor 17. The storage system 16 may be a dedicated memory, such as an EPROM, a hard disk drive (HDD), or flash memory. In some embodiments, the storage system 16 may be an external storage device, such as an external hard disk, a storage card, or a data storage medium.

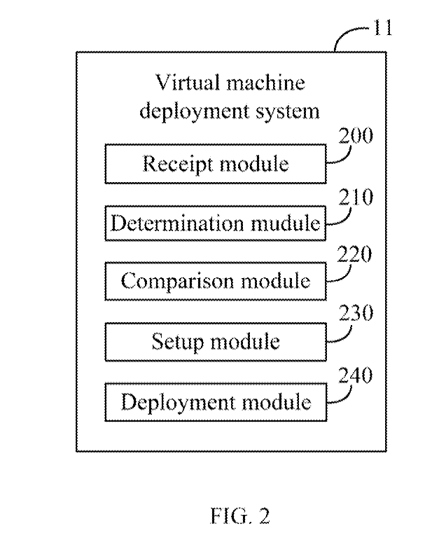

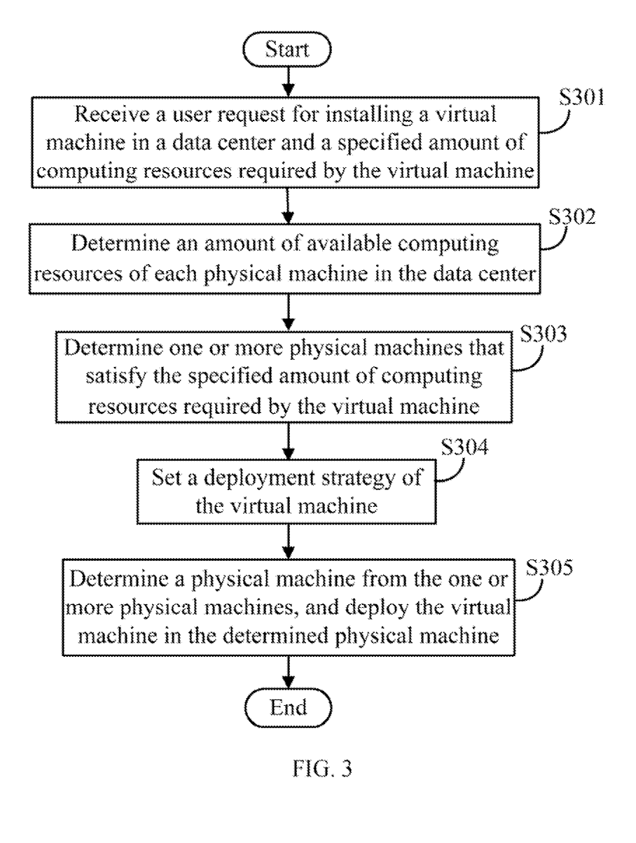

FIG. 2 is a block diagram of one embodiment of function modules of the virtual machine deployment system 11 in FIG. 1. The virtual machine deployment system 11 includes a receipt module 200, a determination module 210, a comparison module 220, a setup module 230, and a deployment module 240. The modules 200-240 may comprise computerized code in the form of one or more programs that are stored in the storage system 16. The computerized code includes instructions that are executed by the at least one processor 17, to provide the aforementioned functions of the virtual machine deployment system 11. A detailed description of the functions of the modules 200-240 is given in reference to FIG. 3.

FIG. 3 is a flowchart of one embodiment of a method for deploying a virtual machine in the data center 12 using the control computer 10 of FIG. 1. Depending on the embodiment, additional steps may be added, others removed, and the ordering of the steps may be changed.

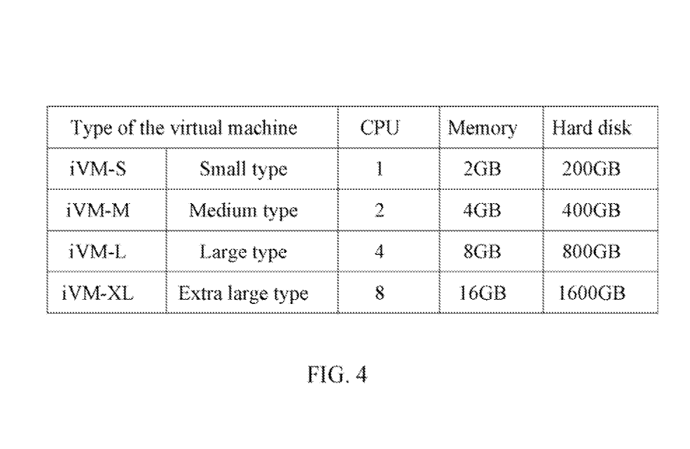

In step S301, the receipt module 200 receives a user request for installing a virtual machine in the data center 12 from a client computer 15, and receives a specified amount of computing resources required by the virtual machine. The computing resources required by the virtual machine may include CPU resource, memory resource, and hard disk resource. In one embodiment, the amount of computing resources required by the virtual machine is determined according to a type of the virtual machine specified by the user. In one example with respect to FIG. 4, there are four types of virtual machine: a small type (represented by “iVM-S”), a medium type (represented by “iVM-M”), a large type (represented by “iVM-L”), and an extra large type (represented by “iVM-XL”). A virtual machine with the small type requires 1 CPU, 2 GB memory, and 200 GB hard disk. A virtual machine with the medium type requires 2 CPUs, 4 GB memory, and 400 GB hard disk. A virtual machine with the large type requires 4 CPUs, 8 GB memory, and 800 GB hard disk. A virtual machine with the extra large type requires 8 CPUs, 16 GB memory, and 1600 GB hard disk. If the user specifies to install a virtual machine with the medium type, the computing resources required by the virtual machine include 2 CPUs, 4 GB memory, and 400 GB hard disk. In another embodiment, the amount of computing resources required by the virtual machine is entered by the user via an input device (e.g., a keyboard) of the client computer 15. For example, the user specifies the computing resources required by the virtual machine include 1 CPU, 2 GB memory, and 200 GB hard disk.

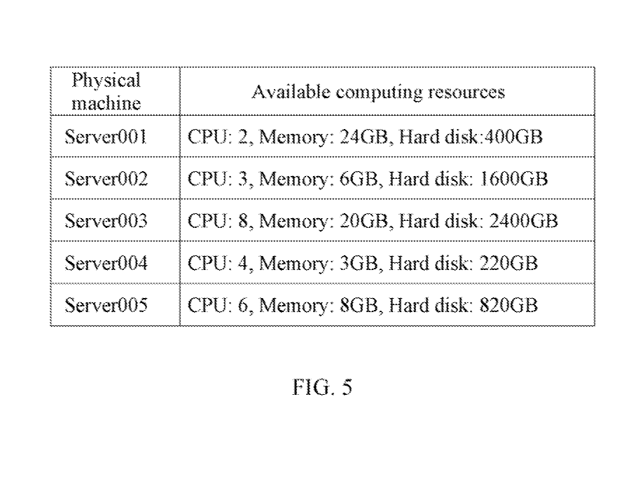

In step S302, the determination module 210 determines an amount of available computing resources of each of the physical machines 13. In one example with respect to FIG. 5, five physical machines 13 denoted as Server001, Server002, Server003, Server004, and Server005 are included in the data center 12. Available computing resources of Server001 include 2 CPUs, 24 GB memory, and 400 GB hard disk. Available computing resources of Server002 include 3 CPUs, 6 GB memory, and 1600 GB hard disk. Available computing resources of Server003 include 8 CPUs, 20 GB memory, and 2400 GB hard disk. Available computing resources of Server004 include 4 CPUs, 3 GB memory, and 220 GB hard disk. Available computing resources of Server005 include 6 CPUs, 8 GB memory, and 820 GB hard disk.

In step S303, the comparison module 220 compares the specified amount of computing resources required by the virtual machine with the amount of available computing resources of each of the physical machines 13, and determines one or more physical machines 13 that satisfy the specified amount of computing resources required by the virtual machine. In one example with respect to FIG. 5, if the virtual machine requires 4 CPU, 8 GB memory, and 800 GB hard disk, Server003 and Server005 are determined to satisfy the specified amount of computing resources required by the virtual machine.

In step S304, the setup module 230 sets a deployment strategy of the virtual machine. In one embodiment, the deployment strategy of the virtual machine includes a uniform deployment strategy, a centralized deployment strategy, a memory priority strategy, a hard disk priority strategy, a user unified deployment strategy, and a distance priority strategy. According to the uniform deployment strategy, virtual machines are uniformly deployed in the physical machines 13, to balance loads of the physical machines 13. According to the centralized deployment strategy, a physical machine 13 is deployed with as many virtual machines as the physical machine 13 can. According to the memory priority strategy, a virtual machine is deployed in a physical machine 13 with the most available memory. According to the hard disk priority strategy, a virtual machine is deployed in a physical machine 13 with the most available hard disk. According to the user unified deployment strategy, virtual machines requested by the same user is deployed in the same physical machine 13. According to the distance priority strategy, virtual machines requested by a user is deployed in a physical machine 13 that is in proximity to the user.

In step S305, the deployment module 240 determines a physical machine 13 from the one or more physical machines 13 according to the deployment strategy of the virtual machine, and deploys the virtual machine in the determined physical machine 13. In one example, if the uniform deployment strategy is set in step S304, the deployment module 240 searches a physical machine 13 with the most available computing resources from the one or more physical machines 13, and deploys the virtual machine in the physical machine 13 with the most available computing resources. In another example, if the centralized deployment strategy is set, the deployment module 240 searches a physical machine 13 with the least available computing resources from the one or more physical machines 13, and deploys the virtual machine in the physical machine 13 with the least available computing resources.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for deploying a virtual machine in a data center comprising a plurality of physical machines being executed by a processor of a control computer, the method comprising:
receiving a user request for installing a virtual machine in the data center, and receiving a specified amount of computing resources required by the virtual machine;
determining an amount of available computing resources of each of the plurality of physical machines;
comparing the specified amount of computing resources required by the virtual machine with the amount of available computing resources of each of the plurality of physical machines, and determining one or more physical machines that satisfy the specified amount of computing resources required by the virtual machine from the plurality of physical machines;
setting a deployment strategy of the virtual machine; and
determining a physical machine from the one or more physical machines according to the deployment strategy of the virtual machine, and deploying the virtual machine in the determined physical machine.

2. The method of claim 1, wherein the specified amount of computing resources required by the virtual machine is determined according to a type of the virtual machine.

3. The method of claim 2, wherein the type of the virtual machine comprises a small type, a medium type, a large type, and an extra large type.

4. The method of claim 1, wherein the computing resources required by the virtual machine comprise CPU resource, memory resource, and hard disk resource.

5. The method of claim 1, wherein the deployment strategy of the virtual machine comprises a uniform deployment strategy, a centralized deployment strategy, a memory priority strategy, a hard disk priority strategy, a user unified deployment strategy, and a distance priority strategy.

6. A control computer, comprising:
a storage system;
at least one processor; and
a virtual machine deployment system comprising one or more programs that are stored in the storage system and executed by the at least one processor, the one or more programs comprising instructions to:
receive a user request for installing a virtual machine in a data center connected to the control computer, and receive a specified amount of computing resources required by the virtual machine;
determine an amount of available computing resources of each of a plurality of physical machines in the data center;
compare the specified amount of computing resources required by the virtual machine with the amount of available computing resources of each of the plurality of physical machines, and determine one or more physical machines that satisfy the specified amount of computing resources required by the virtual machine from the plurality of physical machines;
set a deployment strategy of the virtual machine; and
determine a physical machine from the one or more physical machines according to the deployment strategy of the virtual machine, and deploy the virtual machine in the determined physical machine.

7. The control computer of claim 6, wherein the amount of computing resources required by the virtual machine is determined according to a type of the virtual machine.

8. The control computer of claim 7, wherein the type of the virtual machine comprises a small type, a medium type, a large type, and an extra large type.

9. The control computer of claim 6, wherein the computing resources required by the virtual machine comprise CPU resource, memory resource, and hard disk resource.

10. The control computer of claim 6, wherein the deployment strategy of the virtual machine comprises a uniform deployment strategy, a centralized deployment strategy, a memory priority strategy, a hard disk priority strategy, a user unified deployment strategy, and a distance priority strategy.

11. A non-transitory storage medium storing a set of instructions, the set of instructions capable of being executed by a processor of a control computer to implement a method for deploying a virtual machine in a data center comprising a plurality of physical machines, the method comprising:
receiving a user request for installing a virtual machine in the data center, and receiving a specified amount of computing resources required by the virtual machine;
determining an amount of available computing resources of each of the plurality of physical machines;
comparing the specified amount of computing resources required by the virtual machine with the amount of available computing resources of each of the plurality of physical machines, and determining one or more physical machines that satisfy the specified amount of computing resources required by the virtual machine from the plurality of physical machines;
setting a deployment strategy of the virtual machine; and
determining a physical machine from the one or more physical machines according to the deployment strategy of the virtual machine, and deploying the virtual machine in the determined physical machine.

12. The non-transitory storage medium of claim 11, wherein the amount of computing resources required by the virtual machine is determined according to a type of the virtual machine.

13. The non-transitory storage medium of claim 12, wherein the type of the virtual machine comprises a small type, a medium type, a large type, and an extra large type.

14. The non-transitory storage medium of claim 11, wherein the computing resources required by the virtual machine comprise CPU resource, memory resource, and hard disk resource.

15. The non-transitory storage medium of claim 11, wherein the deployment strategy of the virtual machine comprises a uniform deployment strategy, a centralized deployment strategy, a memory priority strategy, a hard disk priority strategy, a user unified deployment strategy, and a distance priority strategy.
